(19) United States
(12) Patent Application Publication
(10) Pub. No.: US 2025/0029128 A1
(43) Pub. Date: Jan. 23, 2025

(54) MODULAR SENSOR FLOORING SYSTEM

(71) Applicant: Outform Ltd., Moshav Magshimim (IL)

(72) Inventor: Ariel Haroush, North Miami, FL (US)

(73) Assignee: Outform Ltd., Moshav Magshimim (IL)

(21) Appl. No.: 18/778,739

(22) Filed: Jul. 19, 2024

Related U.S. Application Data
(60) Provisional application No. 63/527,667, filed on Jul. 19, 2023.

(51) Int. Cl. G06Q 30/0204; G01L 1/14; G01L 1/16; G01L 1/20; G01L 1/22

(52) U.S. Cl. CPC G06Q 30/0205; G01L 1/146; G01L 1/16; G01L 1/205; G01L 1/22

(57) ABSTRACT

A sensor flooring system is provided comprising a tile body having an upper surface, a lower surface and a periphery, a sensor, operatively associated with the body, the sensor adapted and configured to respond to pressure applied to the flooring tile, a sensor interface adapted and configured to receive a sensor output signal and translate the sensor output signal into a digital message, a network interface module adapted and configured to receive the digital message from the sensor interface and process the digital message, and a network adapted and configure to transmit the digital message from the sensor interface to the network interface module.

### CROSS-REFERENCE TO RELATED APPLICATION

This application claims the benefit of U.S. Provisional Patent Application No. 63/527,667, filed Jul. 19, 2023, the entire contents of which is incorporated herein by reference in its entirety.

### BACKGROUND OF THE INVENTION

Various systems are known for tracking customers within a retail environment, which typically use optical or other imaging techniques to track motion. However, such systems can be difficult to calibrate, install and manage. Furthermore, such systems are often cumbersome to install and maintain, are susceptible to outside interference from devices such as vacuum cleaners. Such systems, especially camera-based systems, also suffer from potential intrusions of privacy, can be compromised by poor placement or movement of store fixtures, and can be susceptible to changes in, or extremes of, lighting brightness and/or color temperature. Accordingly, Applicants recognize that there is a need in the art for simple, adaptable, low cost and robust devices and systems that can be used to track customers within a space, and particularly within a retail environment. The devices, systems and related methods of the present disclosure provide solutions for this need.

### SUMMARY OF THE INVENTION

In accordance with the present invention, devices, systems and methods for monitoring human presence in an environment, particularly within a retail environment, are provided that are adaptable to different spaces and applications, and that durable and relatively inexpensive to fabricate and deploy. Advantageously, the subject systems utilize sensors that detect footsteps, and in accordance with a preferred aspect do not use cameras. Accordingly, data can be collected while still providing more privacy to customers than camera-based systems might.

In accordance with one aspect a sensor flooring tile is provided comprising a tile body having an upper surface, a lower surface and a periphery, and a sensor, operatively associated with the body, the sensor adapted and configured to respond to pressure applied to the flooring tile.

The sensor can be applied to the upper surface of the body. The sensor can be applied to the lower surface of the body. The sensor can be adhered to the body with an adhesive material. The sensor can be embedded in the body between upper and lower surfaces. The sensor can include a plurality of sensors. The plurality of sensors can be arranged in an array. The sensor can be a resilient binary switch, closing a circuit in response to a force above a predetermined threshold. The sensor can be a proportional material, outputting a signal proportional to a force applied thereto. The sensor can be a piezoelectric material outputting varying voltage signal proportional to the force applied thereto. The sensor can include a capacitive material outputting varying capacitance signal proportional to the force applied thereto. The sensor can include a strain gauge material outputting varying resistance signal proportional to the force applied thereto.

A sensor interface can be provided, which is adapted and configured to receive a sensor output signal and translate the sensor output signal into a digital message over a network. The sensor interface can be adapted to monitor traffic on the network and delay sending message on the network until no other network traffic. The delay can be programmed to be a random delay. The delay can be programmed to be a unique delay based on a unique identifier of the sensor interface.

The sensor interface can be adapted to await a message received confirmation signal from a network interface module and if confirmation signal is not received within a predetermined period of time, retransmit message.

The sensor interface can include a memory adapted and configured to store a lifetime sensor actuation cycle count.

In accordance with another aspect of the present invention, a sensor flooring system is provided comprising a tile body having an upper surface, a lower surface and a periphery, a sensor, operatively associated with the body, the sensor adapted and configured to respond to pressure applied to the flooring tile, a sensor interface adapted and configured to receive a sensor output signal and translate the sensor output signal into a digital message, a network interface module adapted and configured to receive the digital message from the sensor interface and process the digital message, and a network adapted and configure to transmit the digital message from the sensor interface to the network interface module.

The network interface module can be adapted and configured to receive the digital message from the network interface module, de-encode the digital message, read a tile identifier from the message, read activation data from the message, and retransmit processed data electronically to an attached device.

The activation data can include a duration of sensor activation. The activation data can include a time stamp.

The network interface module can be further adapted and configured to receive and store physical location data of the tile body and correlating identifier information of the sensor interface.

In accordance with still a further aspect of the invention, a method of tracking customer engagement within a retail environment comprises the steps of providing a tile body having an upper surface, a lower surface and a periphery, providing a sensor, operatively associated with the body, the sensor adapted and configured to respond to pressure applied to the flooring tile, providing a sensor interface adapted and configured to receive a sensor output signal and translate the sensor output signal into a digital message, providing a network interface module adapted and configured to receive the digital message from the sensor interface and process the digital message, providing a network adapted and configure to transmit the digital message from the sensor interface to the network interface module, processing the digital message including the steps of receiving an identifier or address for the sensor interface, correlating the identifier with a predetermined position in space where tile body is situated, receiving sensor activation data, interpreting sensor activation data to determine a presence of a person, filtering data to exclude extraneous data, storing activation frequency and activation duration for each tile body, and transmitting activation frequency and activation duration for each tile body to an attached system.

### BRIEF DESCRIPTION OF THE DRAWINGS

So that those skilled in the art to which the subject disclosure appertains will readily understand how to make and use the devices, systems and methods of the subject disclosure without undue experimentation, embodiments thereof will be described in detail herein below with reference to certain figures, wherein:

FIG. 1 is a top view of a modular tile of sensor flooring system in accordance with one aspect of the invention;

FIG. 2 is a bottom view of a modular tile of sensor flooring system in accordance with one aspect of the invention;

FIG. 3 is a system overview of the subject sensor flooring system;

FIG. 4 illustrates edge and front views of a network interface module for interfacing between a network of a modular tile of sensor flooring system in accordance with the invention;

FIG. 5 illustrates various flow diagrams for a modular tile of sensor flooring system in accordance with the invention;

FIG. 6 illustrates a flow diagram of data reception and processing by a network interface module for a modular tile of sensor flooring system in accordance with the invention;

FIG. 7 illustrates a graphic user interface including example data output for a modular tile of sensor flooring system in accordance with the invention;

FIG. 8 illustrates an example structure of a sensor module having multiple sensors for a modular tile of sensor flooring system in accordance with the invention;

FIG. 9 illustrates an example sensor layout for one tile module of a modular tile of sensor flooring system in accordance with the invention;

FIG. 10 illustrates an alternative example sensor layout for one tile module of a modular tile of sensor flooring system in accordance with the invention;

FIG. 11 illustrates alternative example structures for a sensor of a sensor flooring system in accordance with the invention;

FIG. 12 illustrates another alternative example structure for a sensor of a sensor flooring system in accordance with the invention;

FIG. 13 illustrates still another alternative example structure for a sensor of a sensor flooring system in accordance with the invention;

FIG. 14 illustrates an example structure for a capacitive sensor of a sensor flooring system in accordance with the invention;

FIG. 15 illustrates an example structure and circuit for a piezoelectric sensor of a sensor flooring system in accordance with the invention;

FIG. 16 is a side view illustrating a sensor area provided on an upper surface of a body of a modular tile of a sensor flooring system in accordance with the invention;

FIG. 17 is a side view illustrating a sensor area provided on a lower surface of a body of a modular tile of a sensor flooring system in accordance with the invention; and

FIG. 18 is a side view illustrating a sensor area provided within a body of a modular tile of a sensor flooring system in accordance with the invention.

### DETAILED DESCRIPTION OF THE INVENTION

Reference will now be made to the drawings wherein like reference numerals identify similar structural features or aspects of the subject disclosure.

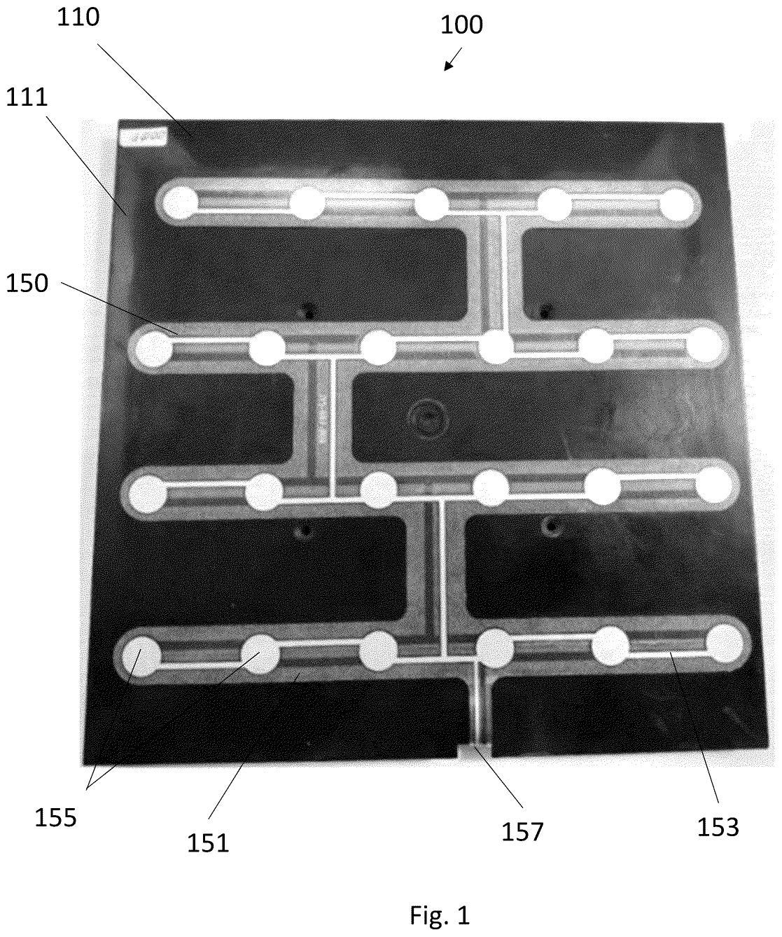

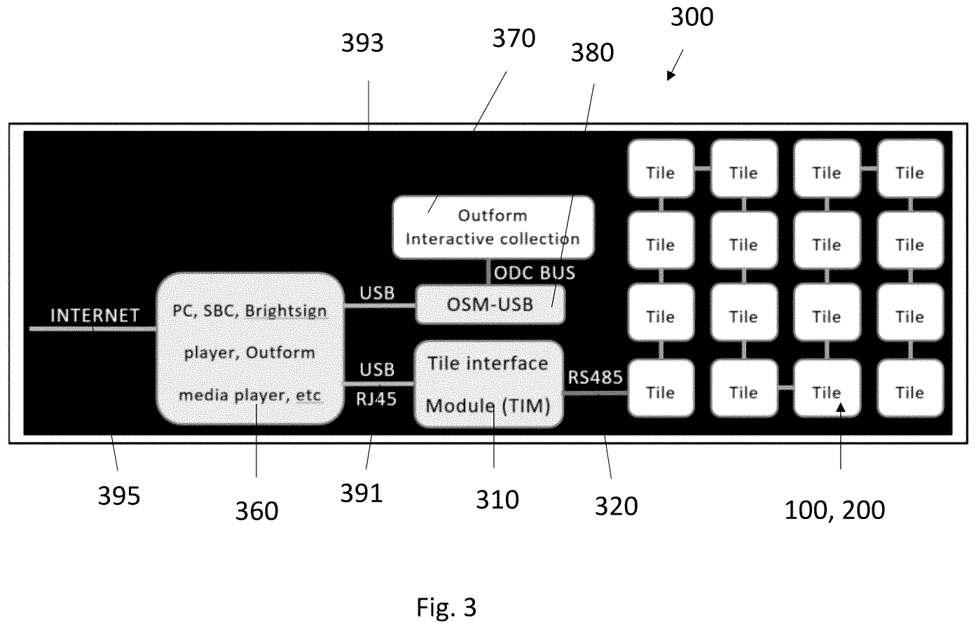

For purposes of explanation and illustration, and not limitation, an exemplary embodiment of a floor module or “tile” for modular floor sensor system in accordance with the present invention is shown in FIG. 1 and is designated generally by reference character 100. An exemplary system is shown in overview in FIG. 3, and is designated generally by reference character 300, and will be discussed in further detail below.

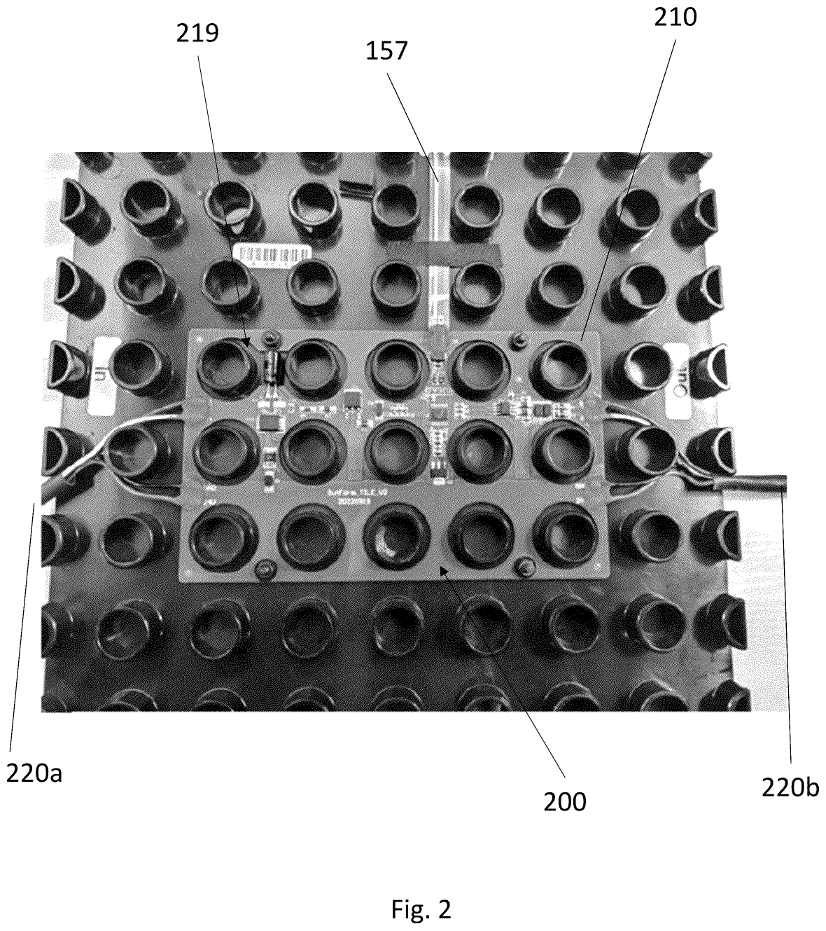

With continued reference to FIG. 1, there is illustrated a floor module 100 for modular floor sensor system in accordance with the invention. The floor module 100 includes a body 110, the upper surface 111 of which is shown. To the upper surface 111 is applied a sensor 150. As embodied, the sensor 150 is an array of multiple detection areas or switches 155. However, it is to be understood that any number of independent discreet sensors can be used. The sensor 150 includes a web or film body 151 onto which multiple switches 155 are applied or formed, which are in-turn connected by wires or circuit traces 153, as embodied. The circuit traces, in-turn lead to a connector 157 for connecting the sensor 150 to a sensor interface module 200, which is illustrated in FIG. 2. This and various other switch configurations will be discussed in further detail below in connection with other figures.

The body 110 of each floor module can be formed of any suitable material, including but not limited to ABS, polycarbonate, polyethylene, fiber-reinforced plastics, Fiberglass, metals, composites, ceramic, wood, or glass.

In accordance with one preferred embodiment, the sensor 150 is a normally-open sensor consisting of several sensor pads 155. In a preferred aspect, the pads 155 have a diameter of between about 13 mm and about 15 mm. The sensor pads 155, in accordance with one aspect, are preferably equally distributed in such a way to ensure a coverage of about 384 sensor pads per square meter.

With reference now to FIG. 2, a sensor interface module 200 is illustrated, and receives the above-described connector 157 from the sensor 150. The sensor interface module 200 is adapted and configured to detect when the sensor is triggered, and respond in various manners, as will be described. The sensor interface module 200 includes a substrate 210, which in this case is a printed circuit board. In a preferred aspect, the sensor interface module 200 is adapted to operate using a serial data network, such as an RS-485 network, which designated generally as reference numeral 320 in FIG. 3. In accordance with a preferred aspect, a predetermined of sensor interface modules 200 of adjacent modules 100 are serially connected or “daisy-chained” to one another, with respect to power and data. Accordingly, external connecting cables 220a, 220b can be interchangeable with regard to function as an input or output.

Various electronic components can be provided on the substrate 210 of the sensor interface module 200. Such modules function to process triggering instances of sensor 150 and communicate that data, as well as, in a preferred aspect, remember certain aspects. As will be discussed in further detail below, parameters such as sensor trigger duration, time, lifetime cycle count, and the like can be monitored, stored in memory and/or transmitted over the network 320.

FIG. 2 also illustrates a manner in which the substrate 210 of the sensor interface module 200 is formed to conform to the structural requirements of the modules 100 and of the system 300 overall. In the illustrated embodiment, various apertures 219 are formed to allow structural elements of the modules 100 to penetrate therethrough.

In accordance with one preferred embodiment, each sensor interface module 200 is provided on a printed circuit board and includes a microprocessor and RS485 interface as well as power management components. In accordance with a preferred aspect, each sensor interface module 200 has a cable on its input side and another on the output side allowing them to be daisy chained in a network. In accordance with another preferred aspect, the size and shape of the sensor interface module 200 is adaptable to fit the tile body 100, having different configurations, or can be configured to fit a purpose-built tile body 100. Each sensor interface module 200 can allow connection of any number of sensors desired. In accordance with one preferred embodiment, any number between 1 and 6 sensors can be individually connected. The sensor interface module 200 can be configured so that connected sensors can transmit as if they are one tile or alternatively can be separated so the sensor interface module 200 will report each sensor activation as a different address, which in-turn can then be mapped in space and graphically represented to a user.

Depending on the implementation, each sensor interface module 200 monitors the number of times each sensor 150 and/or floor module or tile 100 is activated/stepped on. Accordingly, it is possible to predict when a sensor 150/combined sensor and body 100 will reach an unreliable state due to sensor degradation. Maintenance can then be scheduled to replace only the identified tiles 100 or sensors 150, allowing the lifetime of the system 300 to be prolonged indefinitely at low cost, never necessitating replacement of the entire system 300 in order to ensure continued system reliability.

With reference now to FIG. 3, an example modular sensor flooring system 300 is illustrated in accordance with a preferred aspect of the present invention. The system includes one or more floor modules or tiles 100 and their respective sensor interface modules 200 are each connected over a network 320 to a network interface module 310, which receives data over the network 320 and processes the data, as will be described in further detail below. The network interface module 310 is in-turn connected over a data connection 391 to a system controller 360, which can be a computer, for example, or other programmable device, which is configurable to receive data from the interface module 310 and respond in a predetermined fashion. Functionally, the system controller 360 can report data over the internet 395. Additionally or alternatively, the system controller 360 can respond by triggering events, such as display of media, through ancillary adapters 380 and componentry 370 connected by a data connection 393. Accordingly, a retail display having a multimedia element, such as video and/or sound can change its appearance in response to the presence or absence of a person in the vicinity, as detected through the network 320. In accordance with the invention, the physical location of each module 100 and sensor 150 correlates to an identifier or address of a corresponding sensor interface 200. Accordingly, when a sensor 150 is triggered, the system 300 will be able to identify a physical position of a customer and modify display of multimedia content in the vicinity of the customer.

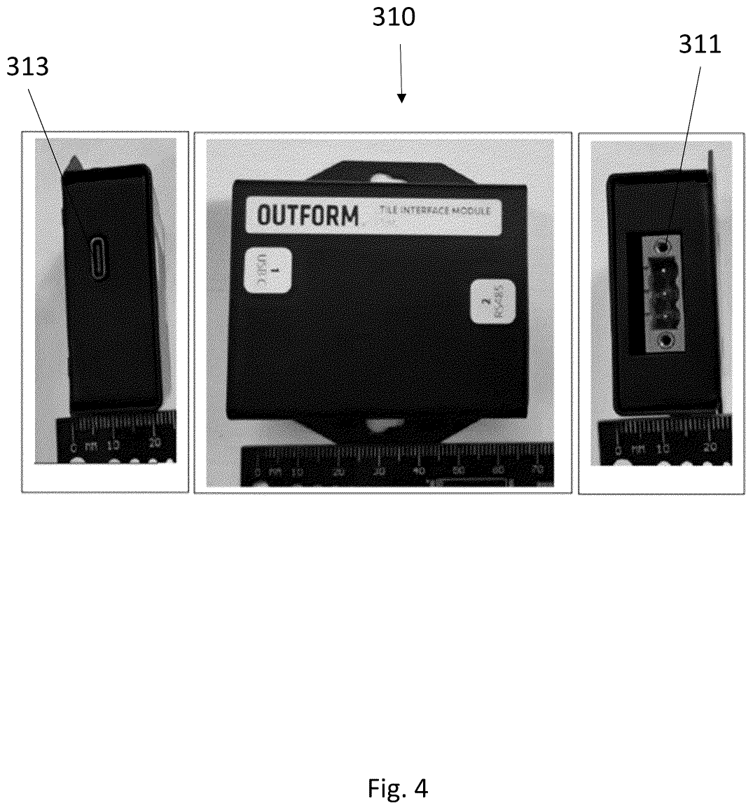

With reference now to FIG. 4, there are illustrated end and front views of a network interface module 310 in accordance with the invention. As embodied, a network connector 311 is adapted and configured to connection to the network 320, while a connection 313 for transmitting data to the rest of the system 300 is also provided, and in this case is a universal serial bus (USB) connection.

The network interface module 310 serves as a bridge between the system controller 360 and floor modules 100. The network interface module 310 performs communication management as well as providing a versatile method of communicating with a cluster of floor modules 100.

In accordance with a preferred embodiment, the network interface modules 310 have an RS485 interface with firmware capable of communicating with a large number of daisy chained floor modules 100. Additionally, the network interface module 310 can have the capability to communicate with a connected computer as a bridge between the computer and network 320.

In accordance with optional aspects of the invention, the network interface module 310 can be equipped to allow communication with a system controller 360 or host PC in one or more ways. USB communication, as illustrated, is useful for when the network interface module 310 can be placed near a system controller 360 or host computer. Ethernet capability is useful when the network interface module 310 cannot be placed next to the system controller 360 or host computer, and/or when an Ethernet network is already available or can be installed easily. Wi-Fi communication capability can be used in cases where a reliable Wi-Fi network is available, and the network interface module 310 cannot be placed close to the system controller 360 or host computer, and wired Ethernet is not a viable option.

In accordance with one preferred embodiment, each floor module 100 can be assigned a unique ID programmed in the factory during testing. Once the sensor 150 of the floor module 100 is triggered the sensor interface 200 of the floor module 100 will broadcast a message containing its address in a specific data packet to indicate the specific floor module 100 has been activated. A timer on the sensor interface 200 of the floor module 100 will be started to determine the duration of the sensor activation. Once the sensor is deactivated, the sensor interface 200 of the floor module 100 will broadcast another message in a specific packet structure indicating its address as well as the duration of the sensor activation. Each the sensor interface 200 of the floor module 100 has an internal counter responsible for counting each sensor activation which will be used to determine the remaining lifetime of the sensor in order to plan and perform preventative maintenance.

In accordance with a preferred embodiment, the sensor interfaces 200 of the floor modules 100 can also have the following abilities which can be controlled by sending the individual sensor interfaces 200 specific messages. Such messages can include but are not limited to the following: Mute-the sensor interface 200 will not report sensor activations; Debounce Time-Setting of the debounce time to accommodate various overlay materials; Query step state-query if the sensor is current activated; Tile Info-Query the hardware, firmware version as well as settings; Disable time reporting-sensor activations will not be reported when the sensors are deactivated.

In accordance with a preferred aspect, all sensor interfaces 200 and network interface modules 310 can be provided with collision detection and avoidance functionality to ensure messages do not get corrupted due to a large number of devices capable of transmitting. Before a sensor interface 200 or network interface module 310 broadcasts a message it polls the communication lines first for a predetermined period of time (e.g., 10 ms) to ensure no other sensor interface 200 or network interface module 310 is currently transmitting. Whenever a message is received by a network interface module 310 or sensor interface 200 the message needs to be acknowledged by sending back the defined acknowledgement package to the sending device. If the sending device does not receive an acknowledgement within a predetermined period of time (e.g., 500 ms) it will attempt to transmit the message again.

The network interface module 310 operates similarly to the sensor interface 200 and provides a buffer between the data packets sent by the sensor interface 200 and system controller 360 or host computer. In accordance with a preferred aspect, if the system controller 360 or host PC sends a message to a specific sensor interface 200 of floor module 100 it will only send that message once. The network interface module 310 will then perform any necessary collision avoidance functions to ensure the message is sent to the specific sensor interface 200 and repeat the message in the event no acknowledgement is received from the target specific sensor interface 200. The network interface module 310 will also receive messages from the specific sensor interface 200 and respond with an acknowledgement and relay the message to the system controller 360 or host computer. These functions performed by the network interface module 310 serve to lessen the processing requirement of the system controller 360 or host computer, leaving it free to perform more complex data analysis functions.

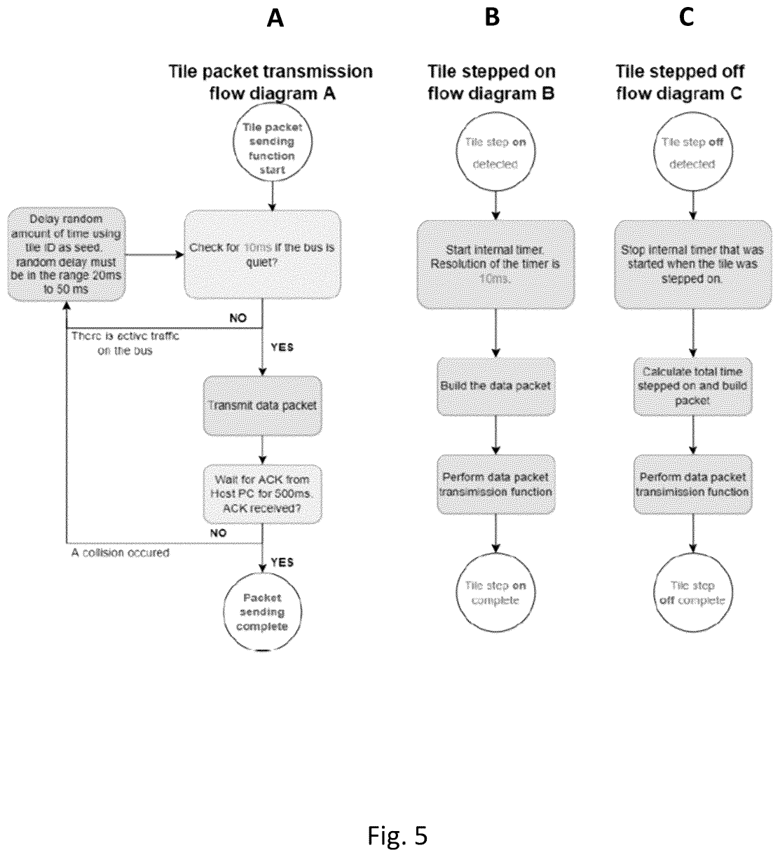

FIG. 5 illustrates various flow diagrams for a modular tile of sensor flooring system in accordance with the invention. Part A illustrates an example packet transmission flow diagram from a sensor interface module 200 over a network 320. Illustrated is an example manner in which collision of data is avoided. Particularly, the sensor interface module 200 monitors the network 320 until a lull in other network traffic is detected. In the illustrated embodiment, the network is monitored for 10 ms, but that duration can vary, depending on the implementation. If quiet, for such predetermined period, a data packet is sent. An acknowledgement message is then awaited. If the network is not quiet for a predetermined amount of time, or if an acknowledgement message is not received, the sensor interface module waits for an amount of time, and then attempts to retransmit the data packet. The period of wait time the sensor interface module 200 waits can be set in various ways. In a preferred aspect, such period of wait time varies for each sensor interface module 200 in the system 300. In the illustrated embodiment, the wait time is programmed to be a random value, within a predetermined range, although the precise implementation can vary. In the illustrated embodiment, a unique ID assigned to each sensor interface module 200 can be used in the selection of wait time, in order to generate a unique wait time from other sensor interface modules, 200, thereby preventing two sensor interface modules 200 from perpetually sending colliding data packets.

In part B of FIG. 5, a flow diagram is shown which illustrates exemplary steps in accordance with one aspect of the invention that commence when a sensor is triggered, or a sensor interface module 200 determines one or more sensors being triggered are a valid footstep, in accordance with the invention. Firstly, a timer is started, which will continue until a footstep is later lifted. A data packet is built, and then transmitted, for example as shown in FIG. 5, part A. Data packets can include interface module ID, sensor input number, in a case of multiple inputs into an interface module, and time stamp.

In part C of FIG. 5, a flow diagram is shown which illustrates exemplary steps in accordance with one aspect of the invention that commence when a sensor trigger ends, or a sensor interface module 200 determines one or more sensors which had been triggered were related to a lifting of a valid footstep, in accordance with the invention. Firstly, the timer started in part B is stopped. A total duration of that footstep is then calculated and built into a data packet, which is then transmitted, for example as shown in FIG. 5, part A. Data packets can include interface module ID, sensor input number, in a case of multiple inputs into an interface module, the aforementioned footstep duration, and optionally also a time stamp.

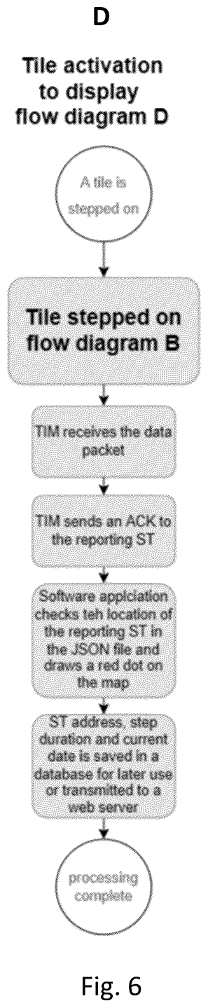

FIG. 6 illustrates a flow diagram of data reception and processing by a network interface module 310 for a modular tile of sensor flooring system 300 in accordance with the invention. The illustrated example shows the receipt of data following initial footstep detection and data packet transmission. In real time, software which can be reside for example in the system controller 360 interprets the information in the data packet and outputs a graphical representation of the footstep in a graphical user interface, which can be directly rendered, or rendered through a webpage and displayed on a remote device, for example.

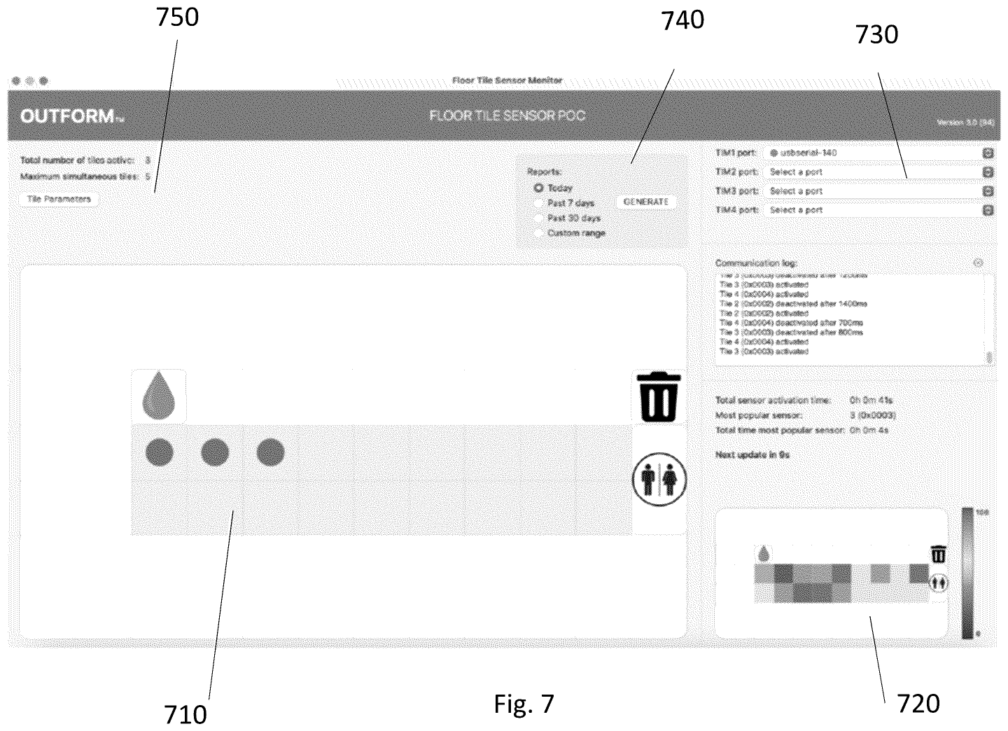

FIG. 7 illustrates a graphic user interface 700 including example graphical data output for a modular tile of sensor flooring system in accordance with the invention. Although the precise implementation can vary, in this example embodiment, region 710 is configured to illustrate live data relating to footstep activity, in this case by a colored change. In the illustrated embodiment, a red circle is rendered for display to indicate an active footstep. In the illustrated embodiment, region 720 is configured to illustrate weighted data collected over a period of time, such as, for example, hours, days, weeks, months, years, system lifetime or a custom time period, selected in region 740. Region 730, as illustrated, shows system configuration information, such as available network interface modules 310 on the network 320. Region 750 is configured in the illustrated embodiment to display desired data such as short-term use data, as illustrated.

The application software is responsible for processing the data received from the network interface module 310. In accordance with a preferred aspect, the data can be analyzed, stored and displayed in a sensible manner. The data can then be used to draw a map of all activated sensors allowing the user to see occupied areas of the monitored space. Additionally, if so embodied, the data can be used to draw a choropleth map or “heatmap” to indicate which parts of the monitored area statistically have the longest sensor activation durations.

The application software can be used to provide a user the ability to locally interface with the sensor tile system 300 as well as push the data to a remote server to allow users in different locations to remotely see the data from individual installations or aggregated results from several locations.

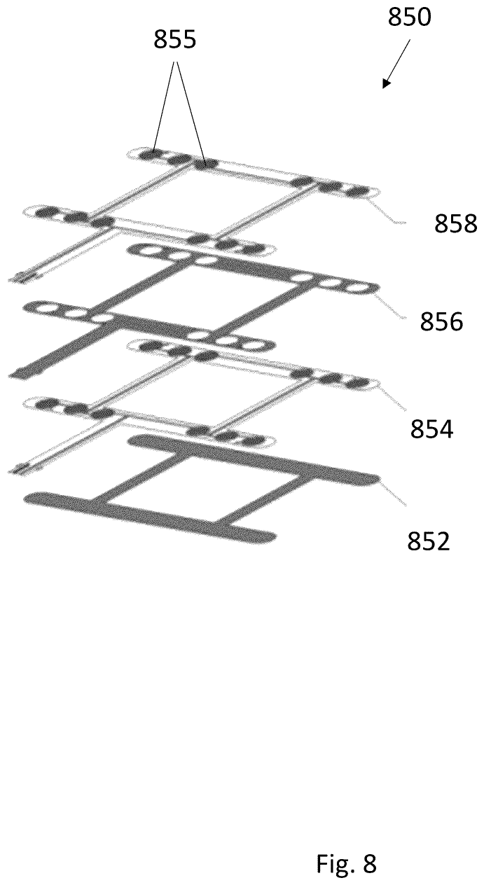

FIG. 8 illustrates an example structure of a sensor module 850 having multiple sensors 855 for a modular tile of sensor flooring system 300 in accordance with the invention. The sensor module 850 is composed of multiple layers, including an optional adhesive layer 852, a bottom circuit 854, spacer 856 and top circuit 858. The bottom 854 and top 858 circuits can be printed or otherwise applied to any suitable, durable thin material, such as a plastic film for example. The spacer 856 can also be formed from any suitable durable material, such as aplastic film. Suitable plastic films for this purpose can include but are not limited to polyethylene (PE) and polyethylene terephthalate (PET). Materials for the printed circuit components can include copper laminates and conductive inks. The illustrated sensors 855 provide a binary signal (on/off) indicating a trigger.

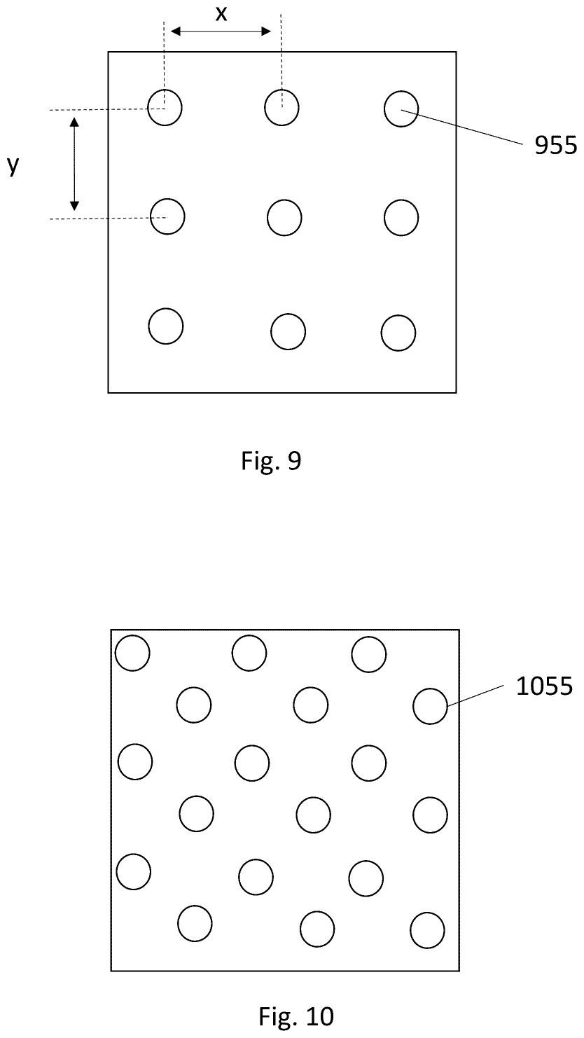

FIGS. 9 and 10 illustrate example sensor layouts for one tile module of a modular tile of sensor flooring system in accordance with the invention. Spacing in the x and y dimensions between sensors or sensor elements 955, 1055 can be selected as desired to ensure that even small feet will trigger at least one sensor. If more sensors are desired, offset alternating rows can be provided, as illustrated in FIG. 10.

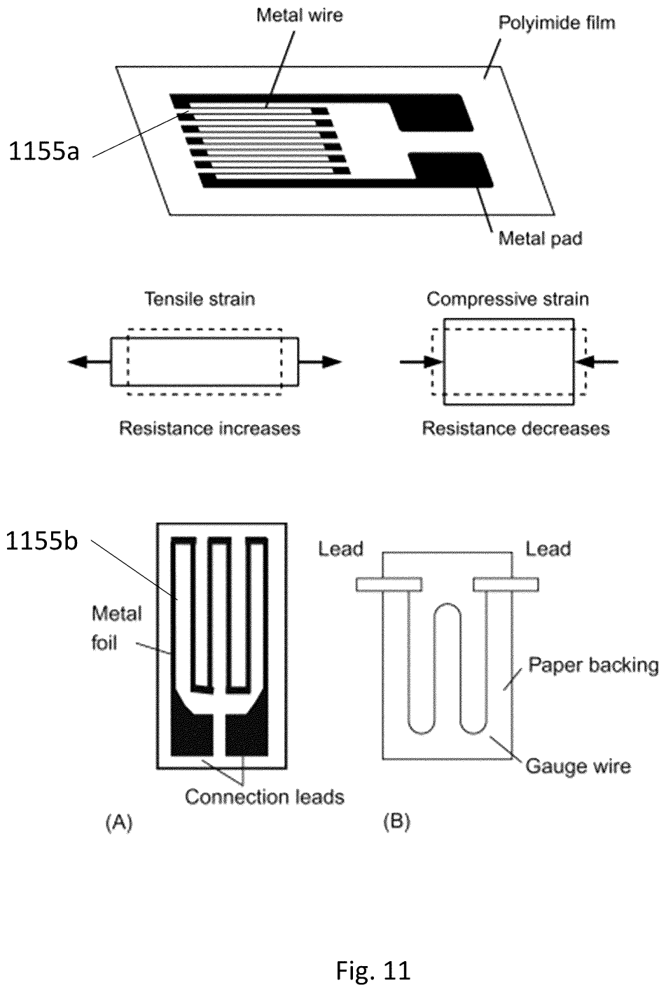

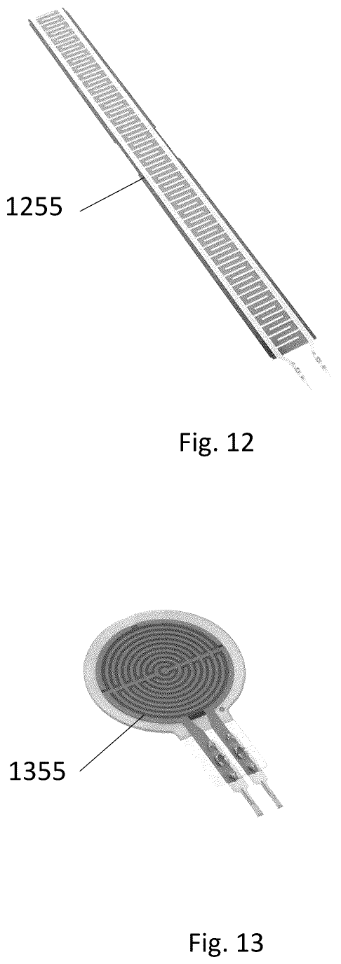

FIGS. 11-13 illustrate optional designs for strain gauge type sensors 1155a, 1155b, 1255, 1355. Such sensors output proportionally variable signals by varying resistance, rather than binary (on/off) signals.

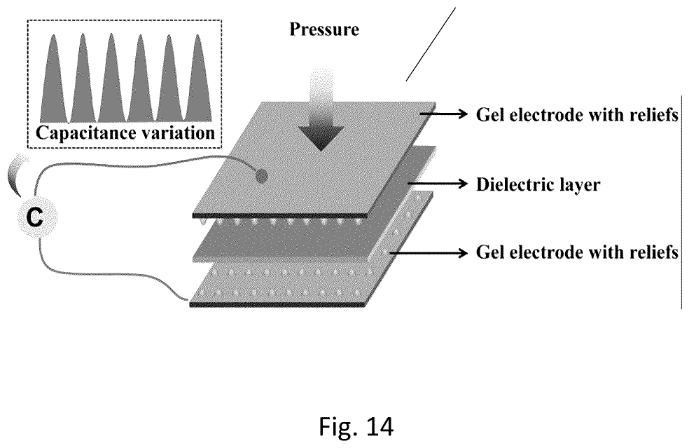

FIG. 14 illustrates an example structure for a capacitive sensor 1455 of a sensor flooring system in accordance with the invention. Such sensors output proportionally variable signals by varying capacitance.

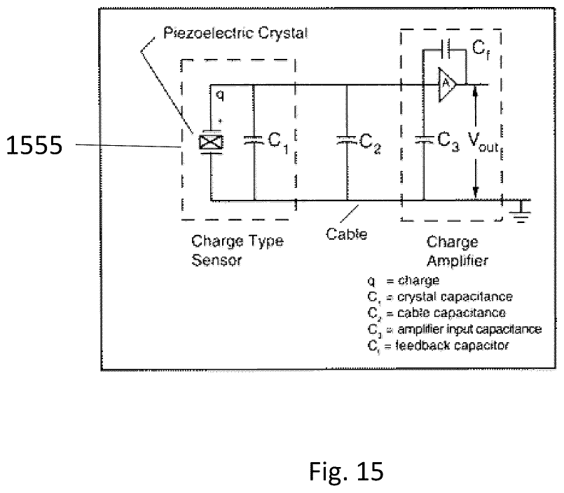

FIG. 15 illustrates an example structure and circuit for a piezoelectric sensor 1555 of a sensor flooring system in accordance with the invention. Such sensors output proportionally variable signals by varying an output voltage.

Additionally, or alternatively, vibration sensors can be utilized to detect a footstep.

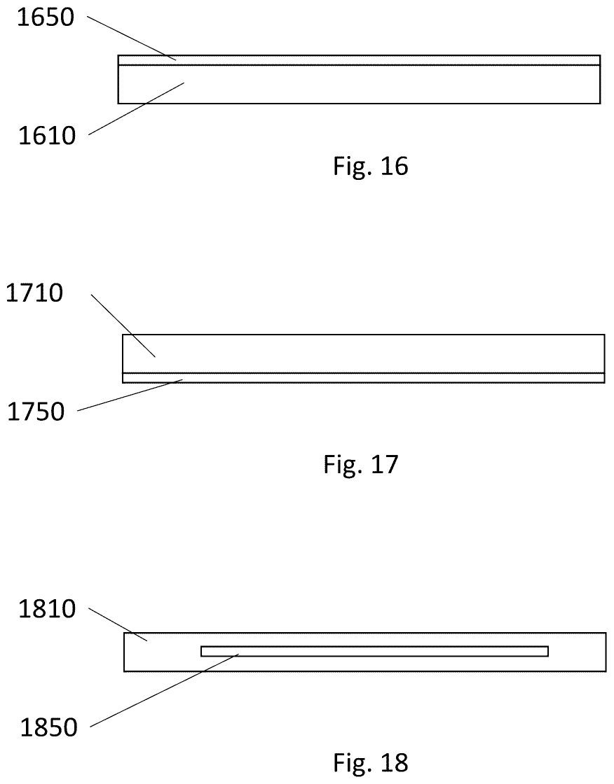

FIG. 16 is a side view illustrating a sensor area 1650 provided on an upper surface of a body 1610 of a modular tile in accordance with the invention. FIG. 17 is a side view illustrating a sensor area 1750 provided on a lower surface of a body 1610 of a modular tile in accordance with the invention. FIG. 18 is a side view illustrating a sensor area 1850 provided within a body 1810 of a modular tile of a sensor flooring system in accordance with the invention.

While the devices, systems and methods of the subject disclosure have been shown and described with reference to embodiments, those skilled in the art will readily appreciate that changes and/or modifications may be made thereto without departing from the spirit and scope of the subject disclosure.

What is claimed is:

1. A sensor floor tile comprising:
a tile body having an upper surface, a lower surface and a periphery; and
a sensor, operatively associated with the body, the sensor adapted and configured to respond to pressure applied to the flooring tile.

2. The sensor floor tile of claim 1, wherein the sensor is applied to the upper surface of the body.

3. The sensor floor tile of claim 1, wherein the sensor is applied to the lower surface of the body.

4. The sensor floor tile of claim 1, wherein the sensor is adhered to the body with an adhesive material.

5. The sensor floor tile of claim 1, wherein the sensor is printed on to the body.

6. The sensor floor tile of claim 1, wherein the sensor is embedded in the body between upper and lower surfaces.

7. The sensor floor tile of claim 1, wherein the sensor includes a plurality of sensors.

8. The sensor floor tile of claim 7, wherein the plurality of sensors are arranged in an array.

9. The sensor floor tile of claim 1, wherein the sensor is a resilient binary switch, closing a circuit in response to a force above a predetermined threshold.

10. The sensor floor tile of claim 1, wherein the sensor is a proportional material, outputting a signal proportional to a force applied thereto.

11. The sensor floor tile of claim 10, wherein the sensor is a piezoelectric material outputting varying voltage signal proportional to the force applied thereto.

12. The sensor floor tile of claim 10, wherein the sensor includes a capacitive material outputting varying capacitance signal proportional to the force applied thereto.

13. The sensor floor tile of claim 10, wherein the sensor includes a strain gauge material outputting varying resistance signal proportional to the force applied thereto.

14. The sensor floor tile of claim 1, further comprising:
a sensor interface adapted and configured to receive a sensor output signal and translate the sensor output signal into a digital message over a network.

15. The sensor floor tile of claim 14, wherein sensor interface is adapted to:
monitor traffic on the network; and
delay sending a message on the network until no other network traffic is detected.

16. The sensor floor tile of claim 15, wherein the delay is programmed to be a random delay.

17. The sensor floor tile of claim 15, wherein the delay is programmed to be a unique delay based on a unique identifier of the sensor interface.

18. The sensor floor tile of claim 14, wherein sensor interface is adapted to:
await a message received confirmation signal from a network interface module; and
if a confirmation signal is not received within a predetermined period of time, to retransmit the message.

19. The sensor floor tile of claim 1, wherein the sensor interface includes a memory adapted and configured to store a lifetime sensor actuation cycle count.

20. A sensor flooring system comprising:
a tile body having an upper surface, a lower surface and a periphery;
a sensor, operatively associated with the body, the sensor adapted and configured to respond to pressure applied to the flooring tile;
a sensor interface adapted and configured to receive a sensor output signal and translate the sensor output signal into a digital message;
a network interface module adapted and configured to receive the digital message from the sensor interface and process the digital message; and
a network adapted and configured to transmit the digital message from the sensor interface to the network interface module.

21. The sensor flooring system of claim 20, wherein the network interface module is adapted and configured to:
receive the digital message from the network interface module;
de-encode the digital message;
read a tile identifier from the message;
read activation data from the message; and
retransmit processed data electronically to an attached device.

22. The sensor flooring system of claim 21, wherein the activation data includes a duration of sensor activation.

23. The sensor flooring system of claim 20, wherein the activation data includes a time stamp.

24. The sensor flooring system of claim 21, wherein the network interface module is further adapted and configured to:
receive and store physical location data of the tile body and correlating identifier information of the sensor interface. 25 A method of tracking customer engagement within a retail environment, the method comprising the steps of:
providing a tile body having an upper surface, a lower surface and a periphery;
providing a sensor, operatively associated with the body, the sensor adapted and configured to respond to pressure applied to the flooring tile;
providing a sensor interface adapted and configured to receive a sensor output signal and translate the sensor output signal into a digital message;
providing a network interface module adapted and configured to receive the digital message from the sensor interface and process the digital message;
providing a network adapted and configure to transmit the digital message from the sensor interface to the network interface module;
processing the digital message including the steps of receiving an identifier for the sensor interface;
correlating the identifier with a predetermined position in space where tile body is situated;
receiving sensor activation data;
interpreting sensor activation data to determine a presence of a person;
filtering data to exclude extraneous data;
storing activation frequency and activation duration for each tile body; and
transmitting activation frequency and activation duration for each tile body to an attached system.
